(19) United States
(12) Patent Application Publication
(10) Pub. No.: US 2006/0077339 A1
(43) Pub. Date: Apr. 13, 2006

(54) Eyeglass frames with lateral supports

(76) Inventors: Shahrooz S. Jamie, Clay, WV (US); Sharon S. Jamie, Clay, WV (US)

Correspondence Address: BOWLES RICE MCDAVID GRAFF & LOVE LLP, POST OFFICE BOX 1386, CHARLESTON, WV, 25325-1386, US

(21) Appl. No.: 10/963,060

(22) Filed: Oct. 12, 2004

(51) Int. Cl. G02C 5/14

(52) U.S. Cl. 351/119

(57) ABSTRACT

A pair of eyeglasses with additional lateral supports for elevating the bridge of the eyeglasses above the nasal bone of the wearers. These supports permit the use of eyeglasses by persons recovering from rhinoplasty. In one embodiment, a support member attaches at one end to the underside of the rear portion of the temple arms, and courses anteriorly, superiorly and medially so that the distal section engages with the zygomatic arch. Another embodiment has a generally straight vertical support member which contacts with and is support by the temporal mandibular joint. A final embodiment is comprised of a support arm, separate from the temple arm, which articulates with the lens frame and which courses superiorly and medially at its distal end to engage with the zygomatic arch.

### BACKGROUND OF THE INVENTION

1. Field of the Invention

The invention disclosed herein relates to eyeglasses and eyeglass frames with alternative means of support on the face.

2. Description of the Related Art

Eyeglasses are commonly used both to improve vision and protect the eyes as well. Typical eyeglass frames are comprised of common structures for positing the frame on the face of the wearer. These structures include temple arms, one end of which loop behind the ears, and a nose bridge or nose pads attached to the nose bridge, which rest upon the nose of a wearer. The two ear loops on the temple arms and the nose bridge or pads provide three points of contact with the face of the user, which provides sufficient support to maintain the frames in a desired position and alignment. The nose bridge or pads support a majority of the weight of the frames. The end loops of the temple arms engage with the cartilage of the ears and prevent the frame from sliding away from or down the nose.

Rhinoplasty, or cosmetic surgery to reshape the nose, is one of the more commonly administered forms of cosmetic surgery procedures. According to the American Society of Plastic Surgeons, in the year 2002 approximately 354,327 rhinoplasty procedures were performed. A substantial recovery period is involved after rhinoplasty, during which the nose is swollen, inflamed and painfully sensitive to touch or pressure. The inflammation and sensitivity usually preclude use of common types of eyeglass frames.

In other cases, the use of conventional eyeglass frames is undesirable because the nose pads cause indentation marks in the skin of the nose, or pull flaccid skin downward, causing cosmetically unappealing wrinkles in the skin around the nose.

The use of contact lenses may alleviate these undesirable consequences, but cannot be worn by or are uncomfortable to many people. Further, contact lenses do not provide any physical protection to the eye, and hard lenses disposed anterior of the eye are still necessary to provide this protection, as well as vision correction.

A number of examples of modified eyeglass frames are available in the prior art. For example, U.S. Pat. Nos. 182,013, issued to Andross on Sep. 12, 1876; U.S. Pat. No. 1,026272, issued to Leveque on May 14, 1912 and U.S. Pat. No. 1,819,738, issued to Daniels on Feb. 23, 1928, each disclose a spectacles or eyeglasses wherein the lenses are supported by a frame that completely encircles the rear of the head. The spectacles are maintained on the head by pressing the frame around the lenses against the socket surrounding the eye using tension in the frame. This method can be uncomfortable and cause irritation to the skin around the eye socket.

U.S. Pat. No. 3,955,885, issued to Aronsohn on May 11, 1976, and U.S. Pat. No. 5,666,182, issued to Donner each disclose an eyeglass frame with a support member disposed, either permanently or removably, to the lower edge of the frame. These are capable of supporting the eyeglass frame off the bridge of the nose, but the positioning of the support member along the lower frame edge causes an obstruction to the downward field of vision, a disadvantage especially for those with bifocal lenses.

An eyeglass frame which supports the frame off the bridge of the nose without interfering with the normal field of vision is desirous.

### SUMMARY OF THE INVENTION

To alleviate or improve upon the disadvantages in the prior art, modifications to conventional eyeglass frames comprise a variety of elements to provide support for the frames on other portions of the wearer's face or head. These alternative support points position the eyeglass frames properly without the need for contact with the nasal bridge.

In one type of embodiment, the eyeglass frame is held in place by an additional support element that disposes onto the zygomatic arch, or the outer cheekbone, the most prominent part of the cheekbone. The support element extends from either the typical temple arm, or from the outer edge of the eyeglass frame.

Another type of embodiment, a support element extends from the temple arm and is disposed onto the mandibular temporal joint.

One objective of this invention is to provide an eyeglass frame with means for elevating the bridge on a typical frame off the nasal bridge.

Another objective is to support an eyeglass frame on the face by a part of the face or head other than the nasal bridge.

Another objective of this invention is to provide such means without impeding vision, especially in the downward direction.

These and other objectives and advantages of the invention will become apparent from the description which follows. In the description, reference is made to the accompanying drawings, which from a part hereof, and in which is shown by way of illustration specific embodiments in which the invention may be protected. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### DESCRIPTION OF THE DRAWINGS

FIG. 1 is a diagram of the prior art, showing a typical pair of eyeglasses worn on a wearer's face.

FIG. 2 is a side elevational view of one embodiment of the invention with a zygomatic support member.

FIG. 3 is a top plan view of the embodiment with the zygomatic support member.

FIG. 4 is a side elevational view of another embodiment of the invention with a separate zygomatic support arm.

FIG. 5 is a top plan view of the embodiment of the invention with separate zygomatic support arms.

FIG. 6 is a side elevational view of another embodiment of the invention with a TMJ support member.

FIG. 7 is a top plan view of the embodiment with the TMJ support member.

### DETAILED DESCRIPTION OF THE PREFERRED EMBODIMENTS

The following discussion describes in detail one or more embodiments of the invention. The discussion should not be construed, however, as limiting the invention to those particular embodiments, and practitioners skilled in the art will recognize numerous other embodiments as well. The complete scope of the invention is defined in the claims appended hereto.

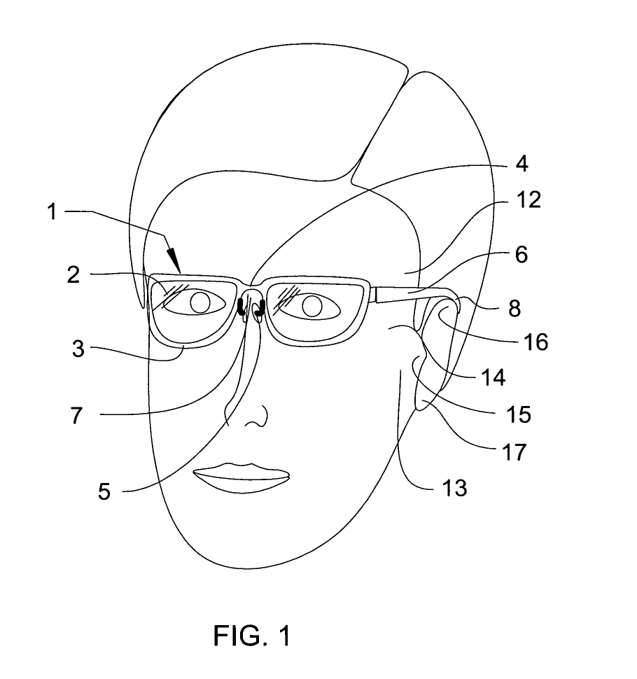

As shown in FIG. 1, a typical pair of eyeglasses common in the art is comprised of a pair of transparent lenses 2, each enclosed within a circuitous frame 3, and the two circuitous frames 3 connected by a bridge 4, together forming an eyeglass frame 1. On the lateral sides of each circuitous frame 3 is disposed a temple arm 6, comprised of an elongated member articulating, usually pivotally, to the eyeglass frame 1 at its proximal end and having an arcuate ear loop 8 at the other distal end. The bridge 4 is either shaped to conform with the shape of a typical nasal bone 7, or has disposed on it a pair of nose pads 5. The nose pads 5 may be fixed or adjustable, and are designed to rest of either side of the nasal bone 7.

In another embodiment of conventional eyeglasses frames 1 common in the art, not shown, the lenses 2 are not enclosed with a circuitous frame 3, but rather the bridge 4, nose pads 5 and temple arms 6 articulate directly with the lenses 2 and are attached by a combination of adhesives, clamps and/or fasteners.

Returning to FIG. 1, conventional eyeglasses are worn by resting the bridge 4, or the nose pads 5, if so equipped, on the nasal bone 7 and then engaging the ear loops 8 around the helix 16 of the ear. The friction of the nose pads 5 prevent the eyeglass frame 1 from sliding down the nose, while the tension from the ear loops 8 maintain the eyeglass frame 1 in vertical alignment in front of the eyes.

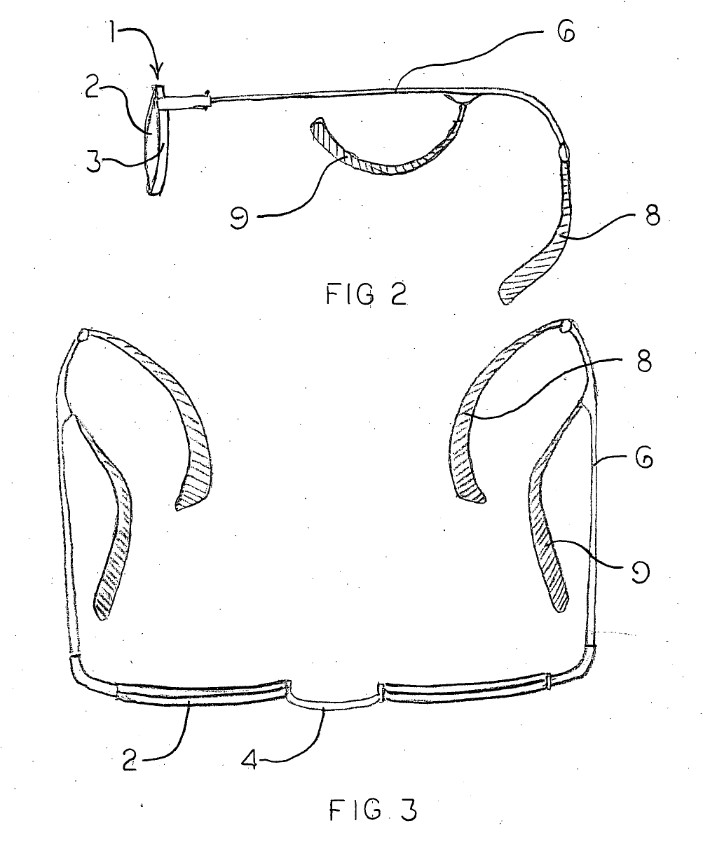

To achieve the objective of the present invention in providing a means for elevating the eyeglass frame 1 off the nasal bone 7 and supporting it by another part of the face or head, the invention disclosed herein provides, in one embodiment, an additional support member which rests upon the zygomatic arch 14, shown in FIG. 1. The zygomatic arch 14 is the bony structure extending from the lateral side of the zygomatic bone, commonly known as the cheekbone, starting from a point below the lateral corner of each eye, and extending posteriorly towards the ear and articulating with the temporal bone 12. To utilize the zygomatic arch 14 for support, one embodiment of the present invention, shown in FIGS. 2 and 3, has an additional zygomatic support member 9 disposed on the temple arms 6 of conventional eyeglasses. In this embodiment, the zygomatic support member 9 is curvilinear in shape, fabricated of a relatively stiff material but having sufficient flexibility to be manually shaped, but sufficiently resilient to avoid deformation during normal use. Preferably, the zygomatic support member 9 is comprised of a metallic wire core, surrounded by a molded polymeric or elastomeric sheath. The sheath may be molded to conform with the contour of the part of the face upon which the end of the zygomatic support member 9 is intended to rest. An expanded width in the sheath at the distal end of the zygomatic support member 9, along the length of contact with the face, is desirable for increased comfort and greater friction to hold the eyeglasses in place.

The zygomatic support member 9 attaches at its proximal end to the inferior or lower edge of the temple arm 6. The zygomatic support member 9 may attach to the temple arm 6 at any point along the length of the temple arm 6 from the median back to the start of the arcuate section forming the ear loop 8. Various methods of joining the zygomatic support member 9 to the temple arm 6 known in the art may be utilized, such as soldering.

The proximal end of the zygomatic support member 9 joins at an acute angle with the anterior section of the temple arm 6. The zygomatic support member 9 curves upward (superior) and inward (medial) to the parasagittal plane of the extended temple arms 6, to dispose the distal end of the zygomatic support member 9 onto the zygomatic arch 14 (shown in FIG. 1) on the side of the face. Preferably, the straight distal end of the zygomatic support member 9 forms an angle of approximately 25 to 30 degrees with the temple arm 6. In this configuration, approximately one-half to one inch of the distal end of the zygomatic support member 9 will be in contact with the facial zygomatic arch 14 in FIG. 1. In this position, the zygomatic support member 9 acts as a fulcrum upon which the eyeglasses may pivot with minimal force required on the posterior section of the temple arm 6 necessary to rise up and support the anterior section of the eyeglass frame 1. However, since the center of gravity of the eyeglasses is anterior of the fulcrum provided by the zygomatic support member 9, a small amount of tension in the temple arms 6 is usually necessary to maintain the bridge 4 in nose pads 5 off the nasal bone 7. This additional tension is provided by extending the ear loop 8 further down the rear of the ear, to grip behind the ear lobe 17.

To wear and effectively utilize this embodiment of the invention, the eyeglasses are donned and the zygomatic support member 9 is shaped to gently press against the superior side of the zygomatic arch 14. The glasses will usually have to be removed and the zygomatic support member 9 further shaped to provide slightly more pressure against the face. When the glasses are donned again, the temple arms 6 may then pivot on the zygomatic arch 14, such that stretching the ear loop 8 around the helix 16 and behind the ear lobe 17 will cause the bridge 4 of the eyeglass frame 1 to rise off the nasal bone 7.

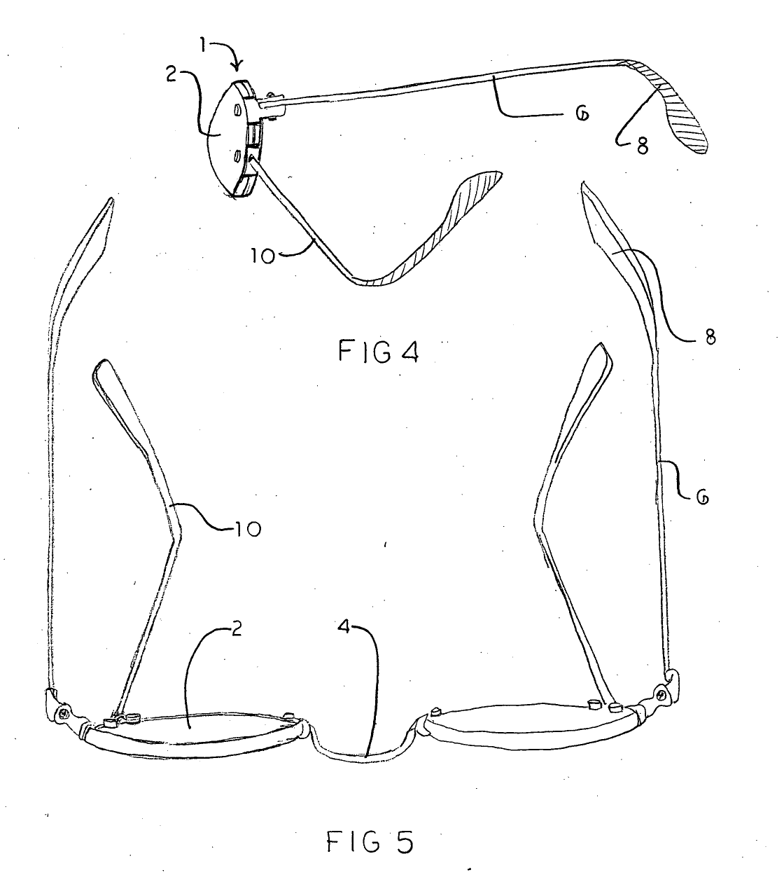

In another embodiment of this type, an independent support for the eyeglasses is comprised of a separate zygomatic support arm 10, separate from and in addition to the temple arm 6, which articulates with the eyeglass frame 1 similarly as with the temple arm 6, either to the circuitous frame 3 around the lenses 2, if provided, or directly to the lenses 2, as shown in FIGS. 4 and 5. The proximal end of independent zygomatic support arm 10 articulates with the outer or lateral edge of the eyeglass frame 1. The articulation between the zygomatic support arm 10 and the eyeglass frame 1 may be fixed or pivotal, consistent with the design of the temple arm 6. In either design, the angle of the zygomatic support arm 10, when in the open, extended position if pivotal, is less than perpendicular with the frontal plane of the eyeglass frame 1, causing the distal end to press gently against the face on the superior side of the zygomatic arch 14, shown in FIG. 1, when the glasses are donned. The zygomatic support arm 10 is substantially straight at either end, and joined medially at a bend in the parasagittal plane, concave upward, which disposes the distal end of the zygomatic support arm 10 at approximately a 25 to 30 degree angle upward from horizontal. The width of the distal end of the zygomatic support arm 10 is expanded to augment the contact area with the facial skin, thereby increasing both comfort and total frictional force for maintaining the placement of the zygomatic arch 14.

As in the first embodiment, the glasses of this embodiment are utilized by extending the temple arms 6 and the zygomatic support arms 10, if pivotal, holding the eyeglasses if front of the face with the lenses 2 aligned with the eyes and sliding the glasses posteriorly as the distal ends of the zygomatic support arms 10 contact the cheekbone and the zygomatic arch 14. The ear loops 8 are then fitted behind the ears, pulling slightly on the ear loop 8 to raise the bridge 4 off the nasal bone 7. In this embodiment, the location and configuration of the fulcrum provided by the zygomatic support arm 10 relieves the need for an extension of the ear loop 8.

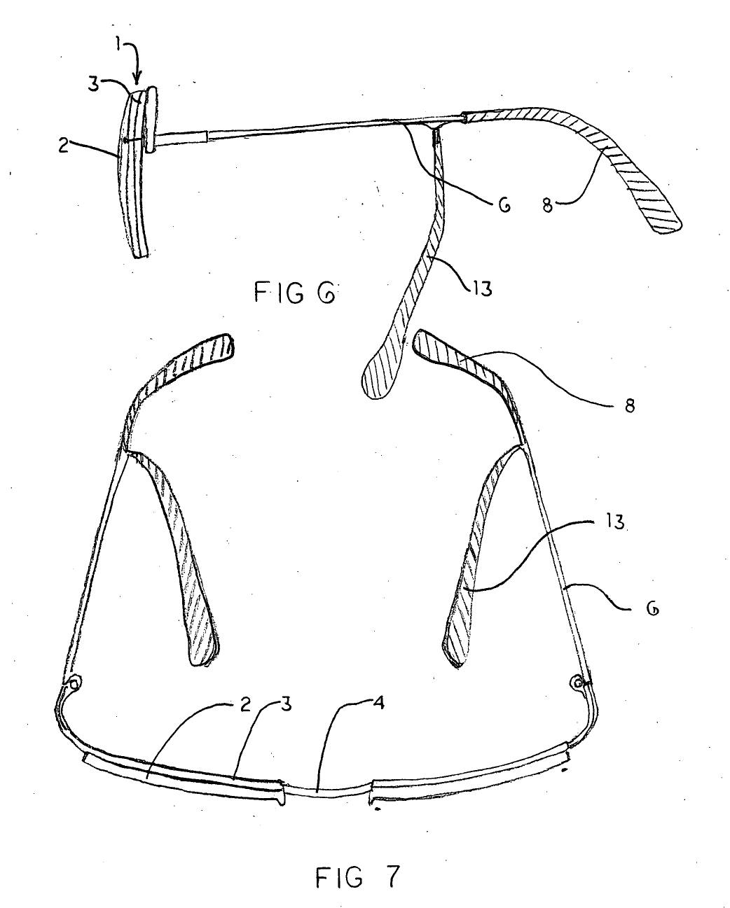

In another embodiment of the invention, as shown in FIGS. 6 and 7, the eyeglasses are provided with an additional support member that rests upon the temporal mandibular joint, specifically upon the mandibular condyle 13, shown in FIG. 1, the bony protuberance located slightly anterior of the tragus 15 of the ear, also shown in FIG. 1. This TMJ support member 11 engages at its proximal end with the inferior edge of each temple arm 6. The TMJ support member 11 articulates with the temple arm 6 at a substantially perpendicular angle. The TMJ support member 11 is slender and generally straight, except for a slight bend in the parasagittal plane, which slightly angles the distal end anteriorly. The width of the TMJ support member 11 expands towards the distal end, to provide more contact area with the side of the head. The length of the TMJ support member 11 is preferably sufficient to extend to a point horizontally aligned with the lower part of the tragus 15 of the ear. The TMJ support member 11, like the zygomatic support member 9, is formed of a slightly flexible, resilient material and has a wire core with a polymeric or elastomeric sheath. The TMJ support member 11 is shaped with a slight medial arc to gently press against the mandibular condyle 13 area when the glasses are donned. The TMJ support member 11 can thus support the weight of the glasses, permitting the bridge 4 of the eyeglass frame 1 to be pivoted off the nasal bone 7 by stretching the ear loop 8 behind the ear.

While various embodiments of the invention have been described above, it should be understood that they have been presented by way of example, and not limitation. It will be apparent to person skilled in the relevant art that various changes in form and detail may be made therein without departing from the spirit, and scope and application of the invention. This is especially true in light of technology and terms within the relevant art that may be later developed. Thus, the present invention should not be limited by any of the above-described exemplary embodiments, but should only be defined in accordance with the appended claims and their equivalents.

We claim:

1) Eyeglasses with lateral supports, comprised of:
a) a pair of lenses with inner and outer edges;
b) a bridge disposed between the inner edges of the pair of lenses;
c) a pair of temple arms, each with a distal end and a proximal end, an ear loop disposed on the distal end and disposes at its proximal end at the outer edge of; and,
d) a pair of support members, each of which said support members having a first end disposed on the temple arm between the ear loop and the median of the temple arm.

2) The eyeglasses of claim 1, wherein one end each of the pair of support members articulates with the inferior edge of the temple arm.

3) The eyeglasses of claim 1, wherein each of the pair of support members is biased substantially towards the proximal end of the temple arms.

4) The eyeglasses of claim 1, wherein the first end of each of the pair of support members articulates with the temple arm at an acute angle to the proximal end of the temple arm.

5) The eyeglasses of claim 4, wherein the angle formed between the support member and the proximal side of the temple arm is between 25 and 30 degrees.

6) The eyeglasses of claim 1, wherein a distal section of the support member is biased medially from the plane containing the temple arm and ear loop.

7) The eyeglasses of claim 1, wherein the support member articulates substantially perpendicular with the temple arm.

8) The eyeglasses of claim 7, where a distal section of the support member is biased anteriorly with the plane formed by the temple arm and ear loop.

9) The eyeglasses of claim 1, further comprised of a pair of nose pads disposed between the inner edges of the pair of lenses.

10) The eyeglasses of claim 1, wherein the one of each temple arm articulates with one of each lens and the bridge articulates with the inner edge of each lens.

11) The eyeglasses of claim 1, further comprises of a pair of circuitous frames, wherein each lens is circumscribed by the circuitous frame, the bridge is disposed between and articulates with each circuitous frame, and one of each temple arms articulates with one of each lens.

12) Eyeglasses with lateral supports, comprised of:
a) a pair of lenses, with inner and outer edges;
b) a bridge disposed between the inner edged of the pair of lenses;
c) a pair a temple arms, each with a distal end and a proximal end, and ear loop disposed on the distal end, and the proximal end disposed at the outer edge of one lens; and,
d) a pair of support arms, each with a proximal end disposed at the outer edge of one lens and a distal end.

13) The eyeglasses of claim 12, wherein the support arms pivotally articulate with the lens.

14) The eyeglasses of claim 13, wherein the range of pivotal articulation of the support arm is less than ninety degrees.

15) The eyeglasses of claim 12, wherein the length of each support arm is less than the temple arms.

16) The eyeglasses of claim 12, wherein the length of each support arm is greater than one-half the length of the temple arms.

17) The eyeglasses of claim 12, wherein the proximal ends of the support arms are disposed at the lens inferior to the proximal end of the temple arm co-disposed on the same lens.

18) The eyeglasses of claim 12, wherein a distal section of the support arm is biased towards the temple arm.

19) The eyeglasses of claim 12, wherein a distal section of each support arm is biased medially.
